(19) United States
(12) Patent Application Publication
(10) Pub. No.: US 2020/0288382 A1
(43) Pub. Date: Sep. 10, 2020

(54) INFORMATION TRANSMISSION METHOD AND DEVICE

(71) Applicant: Guangdong OPPO Mobile Telecommunications Corp., Ltd., Dongguan (CN)

(72) Inventor: Yixue Lei, Dongguan (CN)

(73) Assignee: Guangdong OPPO Mobile Telecommunications Corp., Ltd., Dongguan (CN)

(21) Appl. No.: 16/879,590

(22) Filed: May 20, 2020

Related U.S. Application Data
(63) Continuation of application No. PCT/CN2018/098262, filed on Aug. 2, 2018.
(60) Provisional application No. 62/590,995, filed on Nov. 27, 2017.

(51) Int. Cl. H04W 48/14; H04W 74/00

(52) U.S. Cl. CPC H04W 48/14; H04W 74/004

(57) ABSTRACT

An information transmission method and apparatus are provided. The method includes receiving, by a distributed unit (DU), a first System Information (SI) request for target SI from a terminal and forwarding the first SI request to a centralized unit (CU). Upon reception of the first SI request, the CU transmits a first indication of whether to deliver the requested target SI to the terminal. The DU generates a first SI request response based on the first indication, and transmits the first SI request response to the terminal.

### CROSS-REFERENCES TO RELATED APPLICATIONS

This application is a continuation of and claims priority to International Patent Application PCT/CN2018/098262, filed Aug. 2, 2018, which claims priority to U.S. Provisional Application No. 62/590,995, filed Nov. 27, 2017, the contents of which are hereby incorporated by reference in their entirety.

### TECHNICAL FIELD

The disclosure relates to the field of mobile communications, and particularly, to an information transmission method and apparatus, and a network device.

### BACKGROUND OF THE INVENTION

In a long term evolution (LTE) communication system, an evolved NodeB (eNB) configures system information blocks (SIBs) to be broadcasted, and user equipment (UE) receives SIBs after downlink synchronization is done. However, broadcasting too many SIBs occupies too many downlink radio resources in both a physical downlink control channel (PDCCH) and a physical downlink shared channel (PDSCH).

### SUMMARY OF THE INVENTION

Embodiments of the disclosure provide an information transmission method and apparatus, a network device, a chip, a computer readable storage medium, a computer program product, and a computer program.

At a first aspect, an information transmission method is provided. The method includes the following actions. The DU receives a first System Information (SI) request for target SI from a terminal. The DU determines whether to deliver the requested target SI to the terminal based on first configuration information, the first configuration information being arranged to determine at least one of the following: which target SI can be delivered to the terminal, or which target SI cannot be delivered to the terminal. The DU generates a first SI request response based on the determination. The DU transmits the first SI request response to the terminal.

According to the method at the first aspect, upon reception of the on-demand SI request, the DU can send a RAR containing response to the UE earlier without waiting for the CU's response. Thus, it can potential reduce the delay of the response to the on-demand SI request. In case the increased delay causes the UE to miss one SI periodicity, the gain would be rather considerable.

At a second aspect, an information transmission method is provided. The method includes the following actions. A distributed unit (DU) receives a first System Information (SI) request for target SI from a terminal, and forwards the first SI request to a centralized unit (CU). Upon reception of the first SI request, the CU transmits a first indication of whether to deliver the requested target SI to the terminal. The DU generates a first SI request response based on the first indication, and transmits the first SI request response to the terminal.

According to the method at the second aspect, the CU is in charge of whether to broadcast the requested other SI message or not. Therefore, it ensures that the terminal can receive the requested target SI which can be delivered to the terminal.

At a third aspect, an information transmission apparatus is provided. The apparatus includes a distributed unit (DU). The DU is configured to receive a first System Information (SI) request for target SI from a terminal, determine whether to deliver the requested target SI to the terminal based on first configuration information, generate a first SI request response based on the determination, and transmit the first SI request response to the terminal. The first configuration information is arranged to determine at least one of the following: which target SI can be delivered to the terminal, or which target SI cannot be delivered to the terminal.

At a fourth aspect, an information transmission apparatus is provided. The apparatus includes a distributed unit (DU) and a centralized unit (CU). The DU is configured to receive a first System Information (SI) request for target SI from a terminal, forward the first SI request to the CU. The CU is configured to, upon reception of the first SI request, transmit a first indication of whether to deliver the requested target SI to the terminal. The DU is further configured to generate a first SI request response based on the first indication, and transmit the first SI request response to the terminal.

At a fifth aspect, a network device is provided. The network device includes a processor and a memory. The memory stores a computer program, which, when executed by the processor, causes the processor to implement the method described in the first aspect or the method described in the second aspect.

At a sixth aspect, a chip is provided. The chip includes a processor. The processor is configured to call a computer program from a memory and run the computer program, to enable a device installing the chip to implement the method described in the first aspect or the method described in the second aspect.

At a seventh aspect, a computer readable storage medium is provided. The computer readable storage medium stores computer readable instructions, which, when executed by the processor, cause the processor to implement the method described in the first aspect or the method described in the second aspect.

At an eighth aspect, a computer program product is provided. The computer program product includes computer readable instructions, which, when executed by the processor, cause the processor to implement the method described in the first aspect or the method described in the second aspect.

At a ninth aspect, a computer program is provided. The computer program, which, when executed by a processor, cause the processor to implement the method described in the first aspect or the method described in the second aspect.

### BRIEF DESCRIPTION OF THE DRAWINGS

FIG. 1 illustrates a schematic view of an architecture of a communication system according to some embodiments of the disclosure.

FIG. 2 illustrates a flow chart of an information transmission method according to some embodiments of the disclosure.

FIG. 3 illustrates an interactive flow chart of the information transmission method according to some embodiments of the disclosure.

FIG. 4 illustrates a flow chart of another information transmission method according to some embodiments of the disclosure.

FIG. 5 illustrates an interactive flow chart of another information transmission method according to some embodiments of the disclosure.

FIG. 6 illustrates a block diagram of an information transmission apparatus according to some embodiments of the disclosure.

FIG. 7 illustrates a block diagram of another information transmission apparatus according to some embodiments of the disclosure.

FIG. 8 illustrates a schematic block diagram of a network device according to some embodiments of the disclosure.

FIG. 9 illustrates a schematic block diagram of a chip according to some embodiments of the disclosure.

FIG. 10 illustrates a schematic block diagram of a communication system according to some embodiments of the disclosure.

### DETAILED DESCRIPTION OF THE INVENTION

The following clearly and completely describes the technical solutions in the embodiments of the disclosure with reference to the accompanying drawings in the embodiments of the disclosure. Apparently, the described embodiments are merely a part rather than all of the embodiments of the disclosure. All other embodiments obtained by a person of ordinary skill in the art based on the embodiments of the disclosure without creative efforts shall fall within the protection scope of the disclosure.

The embodiments of the disclosure described below can be applied to various communication systems, for example, the Global System of Mobile communication (GSM) system, the Code Division Multiple Access (CDMA) system, the Wideband Code Division Multiple Access (WCDMA) system, the General Packet Radio Service (GPRS). the Long Term Evolution (LTE) system, LTE Frequency Division Duplex (FDD) system, LTE Time Division Duplex (TDD) system, the Universal Mobile Telecommunication System (UMTS) system, the Worldwide Interoperability for Microwave Access (WiMAX), the 5G system, or the like.

It should be understood that, the terms “system” and “network” in the text can be exchanged. The term “and/or” in the text merely describes associations between associated objects, and it indicates three types of relationships. For example, A and/or B may indicate that A exists alone, A and B coexist, or B exists alone. In addition, the character “/” in the text generally indicates that the associated objects are in an “or” relationship.

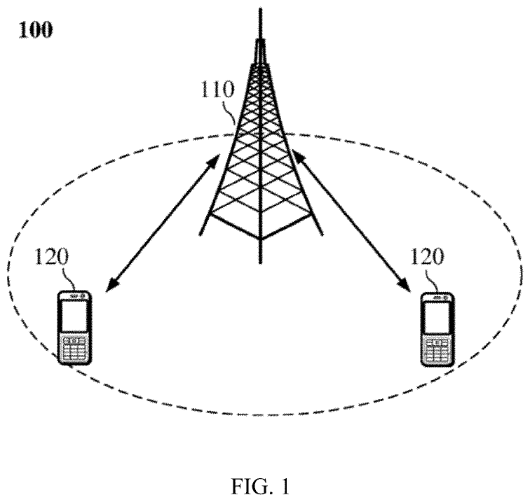

FIG. 1 is a schematic diagram of a communication system 100 applied in an embodiment of the disclosure. The wireless communication system 100 may include at least one network device 110. The access network device 100 may be a device communicating with terminal devices 120 (or called communication terminals, terminals). Each of access network device 100 may provide communication coverage for a specific geographical area, and may communicate with terminal devices within the coverage. The network device 100 may be a Base Transceiver Station (BTS) in a GSM system or a Code Division Multiple Access (CDMA) system, or a NodeB (NB) in a WCDMA system, or an Evolutional Node B (eNB or eNodeB) in an LTE system, or a radio controller in a Cloud Radio Access Network (CRAN). Alternatively, the network device may be a relay station, an access point, a vehicle-mounted device, a wearable device, a core network device in the 5G network, an network device in a future evolved Public Land Mobile Network (PLMN), or the like.

The communication system 100 further includes multiple terminal devices 120 within the coverage of the network equipment 110. The terminal devices 120 may be mobile or stationary. Each of terminal devices 120 may be an access terminal, a User Equipment (UE), a subscriber unit, a subscriber station, a mobile station, a mobile platform, a remote station, a remote terminal, a mobile device, a user terminal, a terminal, a wireless communication device, a user agent, or a user device. The access terminal may be a cellular phone, a cordless phone, a Session Initiation Protocol (SIP) phone, a Wireless Local Loop (WLL) station, a Personal Digital Assistant (PDA), a handheld device having a wireless communication function, a computing device or any other processing device connected to a wireless modem, a vehicle-mounted device, a wearable device, a terminal device in a future 5G network, a terminal device in a future evolved PLMN, or the like.

The terminal devices 120 may communicate with each other through, for example, device to device (D2D) direct connection.

The 5G system or 5G network may be called a new radio (NR) system or an NR network.

FIG. 1 illustrates a network device and two terminal devices. Of course, it should be understood that the communication system 100 may include multiple network devices 110, and a number of terminal devices under coverage of each of the network devices. The number of the network devices and the number of terminal devices are not limited in the embodiments of the disclosure.

The communication system 100 may further include a network controller, a mobile management entity and other network entities, which are not limited here.

As people of ordinary skill in the art can understand, in the embodiments of the disclosure, devices having a communication function in the network/system may be called a terminal device. Taking the communication system 100 as illustrated in FIG. 1 as an example, the terminal device may include the network device 110 and the terminal device 120, each having the communication function. The terminal device may further include other devices in the communication system 100, for example, the network controller, the mobile management entity and other network entities, which are not limited here.

In order to avoid broadcasting too many SIBs, which would occupy quite a lot of downlink radio resources in both PDCCH and PDSCH, an on-demand SI mechanism is introduced and different options are being discussed including MSG1-based, MSG-3-based and Dedicated RRC signaling based approaches.

In a next generation NodeB (gNB), when a distributed unit (DU) receives an MSG1-based on-demand SI request, there is ambiguity issue as such. On one hand, the MSG1-based On-Demand SI request is handled in the media access control (MAC) layer and the DU is able to encode the MSG2 as a response (using the Random Access Response (RAR) procedure). From this perspective, the DU can send RAR (MSG2) with the UE without RRC layer involvement. On the other hand, the request is for other SI which is encoded by a Centralized Unit (CU). Thus, the Radio Resource Control (RRC) layer in the DU may be involved.

For an on-demand SI mechanism, the MSG1-based on-demand SI request uses an RACH process and MSG-3-based/Dedicated RRC signaling-based on-demand SI request uses RRC signaling. For a normal full blown gNB without CU/DU (Centralized Unit/Distributed Unit) split, gNB is responsible to handle the on-demand SI request from the UE and produce a response to the UE. However, in the CU/DU case, the packet data convergence protocol (PDCP) and above layers are located in the CU, and the radio link control (RLC) and below layers are located in DU. In such a case, RAN3 has the following agreements in the last RAN3 meeting and LS is sent to RAN2#100:

The gNB-DU is responsible for the encoding of NR-MIB and RMSI message.

The gNB-CU is responsible for the encoding of other SI messages.

It is to be noted that the other SI mentioned in the embodiment means system information other than NR-MIB and RMSI, and the other SI includes at least one of SIB 1 to SIB 11.

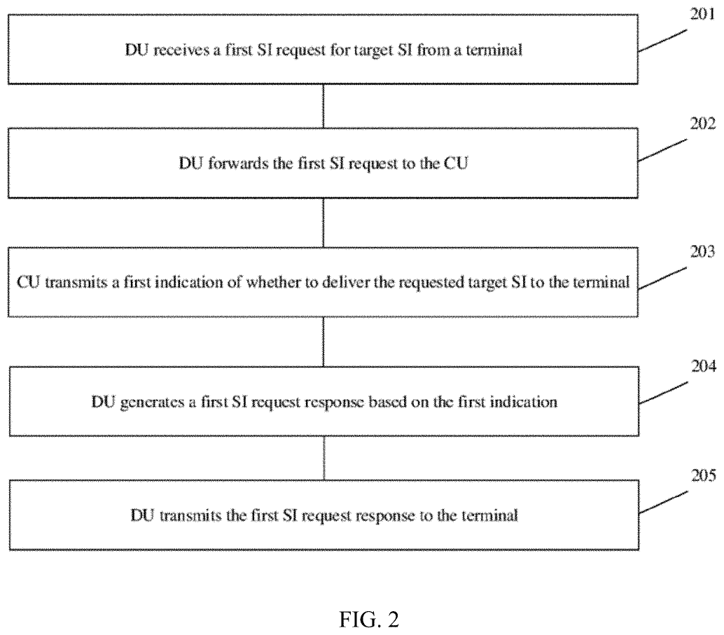

FIG. 2 illustrates a flow chart of an information transmission method according to some embodiments of the disclosure. The information transmission method in these embodiments can be applied to a base station. The base station may be, but is not limited to a gNB in the 5G system. The base station include a DU and a CU. As illustrated in FIG. 2, the information transmission method may include the following actions illustrated in blocks. The method may begin at block 201.

At block 201, the DU receives a first SI request for target SI from a terminal.

At block 202, the DU forwards the first SI request to the CU.

Specifically, during a random access channel (RACH) procedure, the DU receives a first SI request transmitted by the terminal based on MSG1. In other words, the first SI request may be included in the MSG1. Here, the first SI request transmitted based on MSG1 may be called a MSG1-based on-demand SI request. When the DU receives the first SI request transmitted by the terminal, the DU forwards the first SI request to the CU. The CU decides whether to deliver the requested target SI to the terminal. Here, the target SI is also called other SI, i.e., system information other than NR-MIB and RMSI.

At block 203, upon reception of the first SI request, the CU transmits a first indication of whether to deliver the requested target SI to the terminal.

At block 204, the DU generates a first SI request response based on the first indication; and

At block 205, the DU transmits the first SI request response to the terminal.

Specifically, the first SI request response generated by the DU may be a MAC message. During the RACH procedure, the DU receives the first SI request response to the terminal in a second message MSG2. Here, the first SI request response transmitted based on MSG2 may be called a MSG2-based on-demand SI request response.

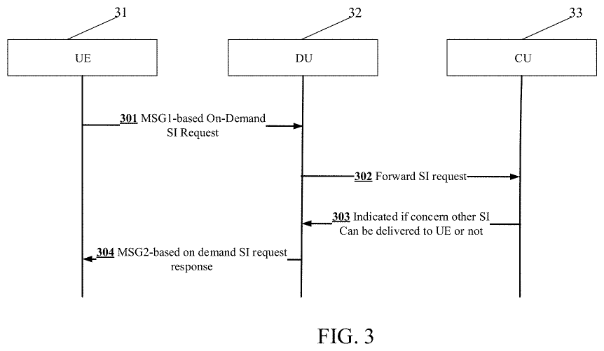

The embodiments of the disclosure will be further described in detail in connection with FIG. 3. As illustrated in FIG. 3, when the DU 32 receives 301 the MSG1-based on-demand SI request based on RACH procedure from the UE 31, the DU 32 firstly forwards 302 the request to the CU 33 and then the CU 33 sends 303 the response to DU which indicates if the requested other SI is available to be delivered or not. Then the DU 32 encodes 304 the MAC RAR message to the UE 31. This ensures that the CU is in charge of whether to broadcast the requested other SI message or not.

However, there are additional latency between the CU and the DU and the UE needs to wait the response. If the requested SI is critical for the UE's on-going service i.e. SI related to safety service for V2X or other critical services, such delay is not desired.

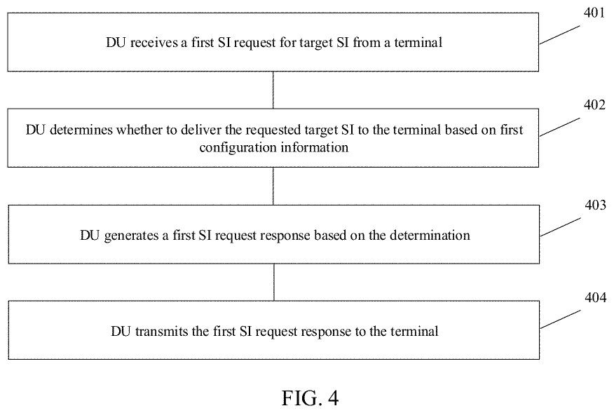

FIG. 4 illustrates a flow chart of another information transmission method according to some embodiments of the disclosure. The information transmission method in these embodiments can be applied to a base station. The base station may be, but is not limited to a gNB in the 5G system. The base station includes a DU and a CU. As illustrated in FIG. 4, the information transmission method may include the following actions illustrated in blocks. The method may begin at block 401.

At block 401, the DU receives a first SI request for target SI from a terminal.

At block 402, the DU determines whether to deliver the requested target SI to the terminal based on first configuration information.

At block 403, the DU generates a first SI request response based on the determination.

Specifically, during the RACH procedure, the DU receives a first SI request transmitted by the terminal based on MSG1. In other words, the first SI request may be included in the MSG1. Here, the first SI request transmitted based on MSG1 may be called a MSG1-based on-demand SI request. Here, when the DU receives the first SI request transmitted by the terminal, the DU does not have to forward the first SI request to the CU. Instead, the DU determines whether to deliver the requested target SI to the terminal based on first configuration information. Here, the first configuration information may be pre-configured configuration information, or configuration information synchronized to the DU from the CU. In this way, upon reception of the first SI request, the DU may immediately determine which target SI can be delivered to the terminal and/or which target SI cannot be delivered to the terminal. Here, the target SI is also called other SI, i.e., system information other than NR-MIB and RMSI.

At block 404, the DU transmits the first SI request response to the terminal.

Specifically, the first SI request response generated by the DU may be a MAC message. During the RACH procedure, the DU receives the first SI request response to the terminal in a second message MSG2. Here, the first SI request response transmitted based on MSG2 may be called a MSG2-based on-demand SI request response.

Further, in some embodiments of the disclosure, while the DU transmits the first SI request response to the terminal, the DU may forward the first SI request to the CU. Upon reception of the first SI request, the CU may transmit a first indication for indicating whether to deliver the requested target SI to the terminal. In this way, the DU can further ensure the decision of the CU regarding whether to deliver the requested target SI to the terminal is the same as the decision of the DU.

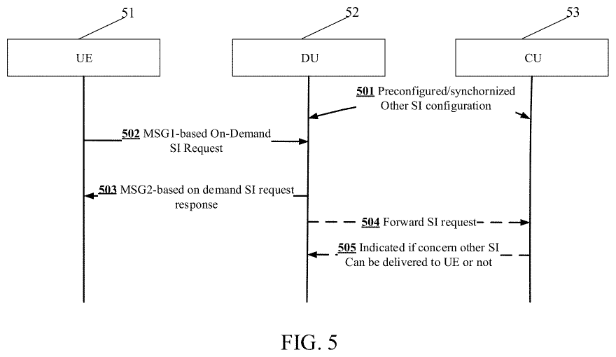

The embodiments of the disclosure will be further described in detail in connection with FIG. 5. As illustrated in FIG. 5, when DU 52 receives 502 the MSG1-based on-demand SI request based on RACH procedure from the UE 51, the DU 52 firstly responds 503 to the UE 51 if the requested other SI is to be broadcasted if by pre-configuration the DU already knows which Other SI can be broadcasted thus it does not need to wait for the response from the CU 53. This requires the CU 53 and the DU 52 are synchronized 501 regarding to which other SIs can be broadcasted to the UE 51.

In some embodiment, the DU 51 may simultaneously send 504 the RAR to the UE and the CU 53, and the CU 503 informs 505 the DU 51 that certain other SI is to be broadcasted. However, it is to be noted that the method can be performed with or without the operations 504 and 505. In other words, operations 504 and 505 are not necessary for implementing the method.

The embodiments described in connection with FIGS. 2 to 5 can solve the problem described in the background section and the embodiments described in connections with FIGS. 4 and 5 can reduce the latency for the UE to receive the RAR response, so that UE can be prepared to receive the concerned other SI in the earliest available SI window. In case the increased delay of embodiments causes the UE to miss one SI periodicity, the gain would be rather considerable.

The above embodiments describe how the MAC and the RRC interact to respond the on-demand SI request. Additionally, the interaction between CU and DU via the F1 interface have been discussed.

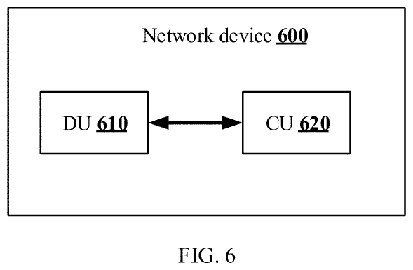

FIG. 6 illustrates a block diagram of an information transmission apparatus according to some embodiments of the disclosure. As illustrated in FIG. 6, the information transmission apparatus includes a DU 610 and a CU 620.

The DU 610 may be configured to receive first System Information (SI) request for target SI from a terminal, and forward the first SI request to the CU 620.

The CU 620 may be configured to upon reception of the first SI request, transmit a first indication of whether to deliver the requested target SI to the terminal.

The DU 610 may further be configured to generate a first SI request response based on the first indication, and transmit the first SI request response to the terminal.

In an embodiment, during a random access channel (RACH) procedure, the DU 610 may be configured to receive the first SI request transmitted by the terminal in a first message MSG1.

In an embodiment, the first SI request response generated by the DU may be a Media Access Control (MAC) message.

In an embodiment, during an RACH procedure, the DU 610 may be configured to transmit the first SI request response to the terminal in a second message MSG2.

As people of ordinary skill in the art can appreciate, the relevant description of the information transmission apparatus in the above embodiments of the disclosure may be understood in light of the relevant description of the information transmission method according to the embodiments of the disclosure.

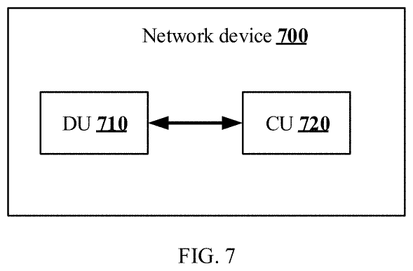

FIG. 7 illustrates a block diagram of another information transmission apparatus according to some embodiments of the disclosure. As illustrated in FIG. 7, the information transmission apparatus includes a DU 710.

The DU 710 is configured to receive a first System Information (SI) request for target SI from a terminal, determine whether to deliver the requested target SI to the terminal based on first configuration information, generate a first SI request response based on the determination, and transmit the first SI request response to the terminal.

In an embodiment, the first configuration information may be arranged to determine which target SI can be delivered to the terminal, and/or which target SI cannot be delivered to the terminal.

The first configuration information may be pre-configured configuration information, or configuration information synchronized to the DU 710 from the CU 720.

In an embodiment, the apparatus may further include a CU 720.

In this embodiment, the DU 710 may be configured to forward the first SI request to the CU 720, while transmitting the first SI request response to the terminal. The DU 710 may be configured to, upon reception of the first SI request, transmit a first indication for indicating whether to deliver the requested target SI to the terminal.

In an embodiment, during an RACH procedure, the DU 710 is configured to receive a first SI request transmitted by the terminal in a first message MSG1.

In an embodiment, the first SI request response generated by the DU may be a MAC message.

In an embodiment, during an RACH procedure, the DU 710 may be configured to transmit the first SI request response to the terminal in a second message MSG2.

As people of ordinary skill in the art can appreciate, the relevant description of the information transmission apparatus in the above embodiments of the disclosure may be understood in light of the relevant description of the information transmission method according to the embodiments of the disclosure.

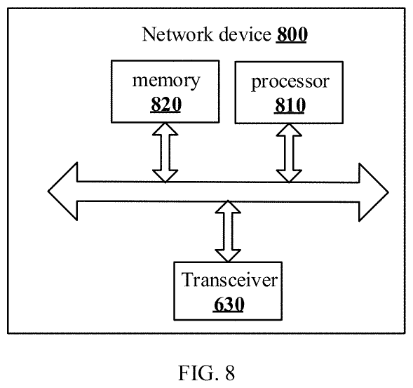

FIG. 8 illustrates a schematic block diagram of a network device 800 according to some embodiments of the disclosure. The network device 800 includes a processor 810 and a memory 820. A compute program is stored in the memory 820. The computer program, when executed by the processor 810, causes the process to implement one of the methods described above.

In an embodiment, the memory 820 may be a device independent from the processor 810, or may be integrated in the processor 810.

The network device 800 may include a transceiver 830. The processor 810 may communicate with other device via the transceiver 830, for example, receive information or data from other device, or send information or data to other device.

The transceiver 830 may include a transmitter and a receiver. The transceiver 830 may further include one or more antennae.

The network device 800 may be the network device as described above and configured to implement one of the processes implemented by the network device as described above. The specific processes will not be elaborated herein for simplicity.

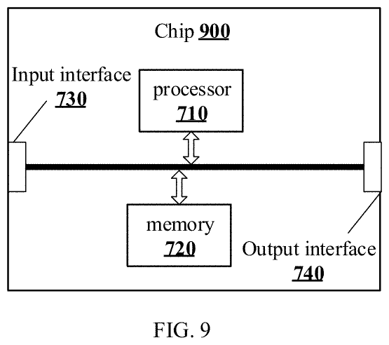

FIG. 9 illustrates a schematic block diagram of a chip according to some embodiments of the disclosure. The chip 800 may include a processor 810, which may call a computer program from a memory to implement the methods as described above.

In an embodiment, the chip 800 may include a memory 820. The processor 810 may call a computer program from a memory 820 to implement the methods as described above.

In an embodiment, the memory 820 may be a device independent from the processor 710, or may be integrated in the processor 710.

In an embodiment, the chip 700 may further include an input interface 730. The processor 710 may control the input interface 730 to perform communication with other device or chip, for example, obtain information or data from other device or chip.

In an embodiment, the chip may further include an output interface 740. The processor 710 may control the input interface 730 to perform communication with other device or chip, for example, output information or data to other device or chip.

In an embodiment, the chip may be applied to the network device as described above. The chip may implement the process performed by the network device as described above. The specific process will not be elaborated here for simplicity.

In an embodiment, the chip may be applied to the terminal device as described above. The chip may implement the process performed by the terminal device as described above. The specific process will not be elaborated here for simplicity.

It is to be noted that the chip mentioned here may be called a system-level chip, a system chip, a chip system or an on-chip system chip.

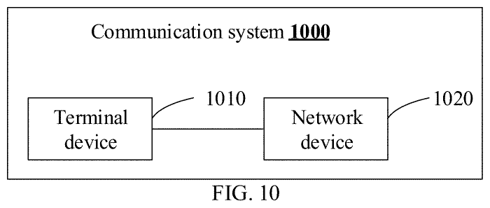

FIG. 10 illustrates a schematic block diagram of a communication system 1000 according to some embodiments of the disclosure. As illustrated in FIG. 10, the communication system includes a terminal device 1010 and a network device 1020.

The terminal device 1010 may be configured to implement the functions of the terminal device as described in the above methods. The network device 1020 may be configured to implement the functions of the terminal device as described in the above methods.

In some embodiments of the disclosure, a computer readable storage medium is provided, storing a computer program.

The computer program may be applied to the network device in the embodiments of the disclosure, and which, when executed by a processor, causes the processor to execute the processes performed by the network device as described above. The specific process will not be elaborated here for simplicity.

The computer program may be applied to the mobile terminal or terminal device in the embodiments of the disclosure, and which, when executed by a processor, causes the processor to execute the processes performed by the mobile terminal or terminal device as described above. The specific process will not be elaborated here for simplicity.

In some embodiments of the disclosure, a computer program product is provided, including a computer program.

The computer program may be applied to the network device in the embodiments of the disclosure, and which, when executed by a processor, causes the processor to execute the processes performed by the network device as described above. The specific process will not be elaborated here for simplicity.

The computer program may be applied to the mobile terminal or terminal device in the embodiments of the disclosure, and which, when executed by a processor, causes the processor to execute the processes performed by the mobile terminal or terminal device as described above. The specific process will not be elaborated here for simplicity.

In some embodiments of the disclosure, a computer program is provided.

The computer program may be applied to the network device in the embodiments of the disclosure, and which, when executed by a processor, causes the processor to execute the processes performed by the network device as described above. The specific process will not be elaborated here for simplicity.

The computer program may be applied to the mobile terminal or terminal device in the embodiments of the disclosure, and which, when executed by a processor, causes the processor to execute the processes performed by the mobile terminal or terminal device as described above. The specific process will not be elaborated here for simplicity.

It should be understood that, the processor mentioned here may be an integrated circuit chip having a signal processing function. The actions described in the above methods may be performed by hardware logic circuits or software instructions in the processor. The processor may be a general purpose processor, a Digital Signal Processor (DSP), an Application Specific Integrated Circuit (ASIC), a Field Programmable Gate Array (FPGA) or the like.

As people of ordinary skill in the art may appreciate, functions of the units in the apparatus as illustrated in the embodiments of the disclosure can be understood based on the above relevant descriptions regarding the information transmission method, and can be implemented by programs running a processor or by logical circuits. The functions of the units in the apparatus may be implemented by programs running in a processor or by specific logical circuits.

The abovementioned memory may include various media capable of storing program codes such as a U disk, a mobile hard disk, a Read-Only Memory (ROM), a Random Access Memory (RAM), a magnetic disk or an optical disk. As such, the embodiments of the disclosure are not limited to any specific combination of software and hardware.

The embodiments of the disclosure may be combined with each other freely without confliction.

In the several embodiments provided in the application, it shall be understood that the disclosed systems, devices and methods may be realized in other modes. For example, the embodiments of the above-described devices are only exemplary, for example, the division of the units is only a logic function division, other division modes may be adopted in practice, e.g., multiple units or components may be combined or integrated in another system, or some characteristics may be omitted or be not executed. From another point of view, the displayed or discussed mutual coupling or direct coupling or communication connection may be indirect coupling or communication connection of devices or units through some interfaces, and may also be in electrical, mechanical or other forms.

The units illustrated as separate components may be or may not be physically separated, and the components displayed as units may be or may not be physical units, that is, the components may be positioned at one place or may be distributed on multiple network units. The objective of the solution of the embodiments may be fulfilled by selecting part of or all of the units according to actual needs.

In addition, in various embodiments of the disclosure, the functional units may be integrated in one processing unit, or the functional units may separately and physically exist, or two or more units may be integrated in one unit. The integrated units may be implemented by hardware or by hardware plus software functional units.

The above is only the specific implementation mode of the disclosure and not intended to limit the scope of protection of the disclosure. Any variations or replacements apparent to those skilled in the art within the technical scope disclosed by the disclosure shall fall within the scope of protection of the disclosure.

What is claimed is:

1. A method for information transmission, the method comprising:
receiving, by a distributed unit (DU), a first System Information (SI) request for a target SI transmitted from a terminal in a first message MSG1 during a random access channel (RACH) procedure;
determining, by the DU, whether to deliver the target SI to the terminal based on first configuration information, which is from a centralized unit (CU), wherein the first configuration information being arranged to determine which target SI can be delivered to the terminal;
generating, by the DU, a first SI request response based on the determination; and
transmitting, by the DU, the first SI request response to the terminal.

2. The method of claim 1 further comprising:
forwarding, by the DU, the first SI request to a centralized unit (CU), while transmitting the first SI request response to the terminal; and
upon reception of the first SI request, transmitting, by the CU, a first indication for indicating whether to deliver the requested target SI to the terminal.

3. The method of claim 1 wherein the first SI request response generated by the DU is a Media Access Control (MAC) message.

4. The method of claim 1 wherein transmitting, by the DU, the first SI request response to the terminal comprises:
during an RACH procedure, transmitting, by the DU, the first SI request response to the terminal in a second message MSG2.

5. The method of claim 1 wherein the DU is a gNB-DU configured for encoding of NR-MIB messages.

6. The method of claim 5 wherein the DU is a gNB-DU further configured for encoding of RMSI messages.

7. The method of claim 1 wherein the first SI request for target SI is an on-demand SI request.

8. The method of claim 1 wherein the first SI request for target SI is a MSG1-based on-demand SI request.

9. The method of claim 8 wherein the MSG1-based on-demand SI request uses an RACH process and Dedicated Radio Resource Control (RRC) signaling-based on-demand SI request uses RRC signaling.

10. The method of claim 1 wherein the CU is a gNB-CU which is configured for encoding of other SI messages.

11. The method of claim 1 wherein the first SI request response generated by the DU is a Media Access Control (MAC) message.

12. The method of claim 1 wherein the first configuration information is synchronized from a centralized unit (CU).

13. The method of claim 1 wherein the first configuration information further arranged to determine which target SI can be delivered to the terminal.

14. An information transmission apparatus comprising:
a distributed unit (DU), configured to:
receive, by the DU, a first System Information (SI) request for a target SI transmitted from a terminal in a first message MSG1 during a random access channel (RACH) procedure;
determine, by the DU, whether to deliver the target SI to the terminal based on first configuration information, which is from a centralized unit (CU), wherein the first configuration information being arranged to determine which target SI can be delivered to the terminal;
generate, by the DU, a first SI request response based on the determination; and
transmit, by the DU, the first SI request response to the terminal.

15. The apparatus of claim 14 further comprising:
a centralized unit (CU),
wherein the DU is configured to forward the first SI request to the CU, while transmitting the first SI request response to the terminal, and
wherein the CU is configured to, upon reception of the first SI request, transmit a first indication for indicating whether to deliver the requested target SI to the terminal.

16. The apparatus of claim 14 wherein the first SI request response generated by the DU is a Media Access Control (MAC) message.

17. The apparatus of claim 14 wherein the DU is configured to, during an RACH procedure, transmit the first SI request response to the terminal in a second message MSG2.

18. The apparatus of claim 14 wherein the DU is a gNB-DU configured for encoding of NR-MIB messages.

19. The apparatus of claim 14 wherein the DU is a gNB-DU further configured for encoding of RMSI messages.

20. A computer-readable storage medium storing computer-executable instructions that, when executed by a computer system, configure the computer system to perform operations comprising:
receiving, by a distributed unit (DU), a first System Information (SI) request for a target SI transmitted from a terminal in a first message MSG1 during a random access channel (RACH) procedure;
determining, by the DU, whether to deliver the target SI to the terminal based on first configuration information, which is from a centralized unit (CU), wherein the first configuration information being arranged to determine which target SI can be delivered to the terminal;
generating, by the DU, a first SI request response based on the determination; and
transmitting, by the DU, the first SI request response to the terminal.
